(19) United States
(12) Patent Application Publication
(10) Pub. No.: US 2003/0061056 A1
(43) Pub. Date: Mar. 27, 2003

(54) Management system and management method for information communications network system

(76) Inventors: Atsushi Yano, Tokyo (JP); Shigetsune Yamoto, Tokyo (JP); Kiyoto Fukamatsu, Tokyo (JP)

Correspondence Address: DARBY & DARBY P.C., P. O. BOX 5257, NEW YORK, NY, 10150-5257, US

(21) Appl. No.: 09/936,140

(22) PCT Filed: Jan. 12, 2001
(86) PCT No.: PCT/JP01/00154

(30) Foreign Application Priority Data
Jan. 12, 2000 (JP) P2000-004070

(51) Int. Cl. G06F 17/60

(52) U.S. Cl. 705/1

(57) ABSTRACT

A management system for an information communications network system is provided which will allow an information communication service provider to obtain information about the quality of communication services to customers through managing the time over which an information communications network system is affected by a problem. A management system (10) for an information communications network system according to the present invention comprises means (12) for recording a problem start time of the information communications network system, means (14) for recording a time of contact made to a customer by a monitor center (30) after the problem has been resolved, and means (16) for computing a problem duration time from the problem start time and from the time of contact to the customer.

### TECHNICAL FIELD

The present invention relates to a management system which manages recovery of an information communications network system and is suitable for use by an information communication service provider who rents a third party an information communications network system and an information communication service provider who rents an information communications network system from a communication company or an information processing service provider. The invention also relates to a management system which manages compensation contracts covering direct damages to information communication service users and expanded damages, caused by an interruption to an information communications network system, when the information communications network system has been unavoidably interrupted for a given period of time.

### BACKGROUND ART

Today, fast data communications networks of about 100 Mbps using optical fibers have been built in Japan, Europe, the United States of America, and the ASEAN countries. With such optical fiber-based fast data communications networks, large enterprises that have multiple footholds in Japan are able to secure the smooth transaction of business information within the company over intra-office LAN's or intranets. Medium and small-sized enterprises and large enterprises can effectively use the Internet or value-added networks (VAN) to do business with other companies.

FIG. 5 is an explanatory diagram of an inter-business information communication system using a conventional fast data communications network. The fast data communications network has an access point AP provided for each of companies A, B, . . . , and Z, and uses, for example, optical fibers or microwaves. As the fast data communications network is connected to a website on the Internet via a fast and large-capacity cache server using IP (Internet Protocol), it is not affected by the heavy use of the Internet or the server and can ensure fast Web access. Each access point AP is connected to the server of each company by an optical fiber, a copper cable, a communication device using an electric light cable, mobile communication radio, Bluetooth, PHS (Personal Handyphone System) or the like.

FIG. 6 is an explanatory diagram of a virtual private information communications network system using a public fast data communications network. The head office of company A and branch offices of company A are registered in the fast data communications network as members of a closed network (Closed User Group). A closed network is a network which does not permit connection by persons other than registered service users and provides a high level of security. Customers, sales offices of company A and employees on business trips access the closed network using the virtual private information communications network system (Virtual Private Network) capability on the Internet. Customers and sales offices of company A connect to the closed network using the encryption and tunneling techniques of IPsec (Security) machines, and an employee on a business trip connects to the closed network by dial-up.

As mentioned above, fast data communications networks are indispensable to intra-business data transaction and commerce between enterprises. Particularly, the interruption of fast data communications networks and the deactivation of servers can potentially threaten the businesses of mail-order dealers and electronic business dealers who run businesses using the infrastructures for information communications, such as e-business, e-services and e-commerce.

However, information communication service providers who rent users fast data communications network have not conventionally conducted business on the premises that users, such as electronic business dealers, occupy. Communication firms that are typical information communication service providers have only been obliged to provide voice phone services in accordance with the regulations that are associated with telegraph and telephone, and have been exempted from liability to compensate for damages incurred by users even in the case where an interruption of communications continues over a long period of time. However, communication firms have been investing a vast amount of money in plant and equipment to build large-capacity fast data communications networks and redundancy networks to avoid such interruptions to communications.

As users are using fast data communications networks as businesses, a certain trade-off between the reliability and cost becomes necessary. That is, while a high level of reliability is needed, high communications costs can prejudice the capacity of electronic business dealers to establish and maintain their businesses and this issue must be addressed.

In view of the above, communication firms have come up with the idea of communication service quality. Communication service quality can be measured from the viewpoint that it permits customers access to an information communications network system having as large a capacity as possible which guarantees fast data transaction both within and between companies and reduces waiting time even when the information communications network system is experiencing heavy traffic. While previously the reestablishment of telecommunication lines has been managed from the viewpoint of managing telecommunications line equipment (see Japanese Patent Application, First Publication No. Hei 10-247909, a patent application to Japan), it has not, however, been managed from the viewpoint of guaranteeing the quality of communication services to customers.

### DISCLOSURE OF INVENTION

The present invention overcomes the aforementioned problems and it is a first object of the present invention to provide a management system for an information communications network system, which will allow communication firms to obtain information about the quality of communication services to customers by managing the duration of interruptions to the information communications network system. It is a second object of the present invention to provide a management system for an information communications network system, which compensates for direct damages incurred by information communication service users and expanded damages, caused by interruptions to an information communications network system, when the information communications network system has been unavoidably interrupted for a given period of time.

To achieve the first object, a management system for an information communications network system according to the present invention is made up of, for example, a recovery management system (10) shown in FIG. 1, and comprises a means (12) for recording a problem start time of the information communications network system, a means (14) for recording a time of contact made to a customer by a monitor center (30) after the problem has been resolved, and a means (16) for computing a problem duration time from the problem start time and from the time of contact to the customer. This facilitates management of the problem duration time affecting the information communications network system for each customer and will allow an information communication service provider to obtain information about the quality of communication services to the customer. Problems affecting an information communications network system include interruptions to the network itself, delays affecting the data that is to be relayed over a network and failure of software or a unit connected to a network.

To achieve the first object, a management method for an information communications network system according to the invention comprises a step of recording a time at which a problem of the information communications network system has started; a step (36) of reporting a recovery process to a customer by a monitor center (30) after detection of the problem; and a step of recording a time of contact made to the customer by the monitor center after the problem has been resolved. According to this management method, even if a problem occurs in an information communications network system, the monitor center reports a recovery process to a customer whenever necessary until the problem has been resolved, so that the customer is aware of the sequence of recovery steps being taken up until the full reactivation of the information communications network system.

To achieve the second object, a management system for an information communications network system according to another aspect of the invention is made up of, for example, a compensation management system (20) as shown in FIG. 1, and comprises means (22) for determining details of compensation to a customer using a problem duration time affecting the information communications network system and compensation criteria (24); means (26) for notifying the customer and an insurer of the details of compensation; and means (28) for making a settlement which allows an information communication service provider who receives insurance money to be paid to the customer by the informed insurer to counterbalance an information communication service charge imposed by the customer with the insurance money.

With this structure, the compensation details determining means autonomously determines the compensation details for a customer based on the problem duration time affecting the information communications network system and compensation criteria. The means for notifying insurer notifies the customer and an insurer of the compensation details determined by the compensation details determining means. The insurance money settling means makes a settlement which allows an information communication service provider who receives insurance money to be paid to the customer by the insurer to counterbalance an information communication service charge imposed by the customer with the insurance money. Accordingly, in the case where the information communications network system has been unavoidably interrupted for a given period of time, it is possible to compensate for direct damages to information communication service users caused by the interruption to the information communications network system. The management system, is designed to have, for example, a server-client structure, and can pay insurance money on-line without assistance. Of course, the payment of insurance money may be executed off-line.

Preferably, the compensation criteria should be set so as to exclude as a matter for compensating a problem when the problem duration time does not reach a given exemption value. Therefore, the triggering of an alarm for a minor problem affecting an information communications network system is excluded as a matter for compensation, thus reducing compensation management costs.

Further, if the compensation criteria are set so as to reduce an information communications network system charge corresponding to the problem duration time when the problem duration time exceeds a given exemption value, the information communication service provider can claim an information communications network system charge from a customer, and the management costs and the execution costs for transferring money can be reduced by decreasing the information communications network system charge instead of paying the insurance money.

If the compensation criteria are set in such a way as to compensate for the problem even when the problem occurs due to a cause for which the information communication service provider is not responsible, risks to the insurer and customers in conducting their business are reduced.

If the compensation criteria are set in such a way as to compensate for damages in a case where a cause for the problem has defamed, or invaded the privacy of, a customer or a third party, or has resulted in damage to equipment, and erasure or alteration of information, this structure contributes to reducing risks when conducting a variety of businesses, excluding the triggering of an alarm in response to a problem affecting an information communications network system caused by electronic commerce.

To achieve the first and second objects, a management method for an information communications network system according to another aspect of the invention comprises the following steps. A first step records a problem start time of the information communications network system. A second step records a time of contact made to a customer by a monitor center after the problem has been resolved. A third step computes a problem duration time from the problem start time and the time of contact to the customer for each target information communications network system of the customer. A fourth step notifies the customer and an insurer of details of compensation to the customer determined by using the problem duration time and compensation criteria. A fifth step makes a settlement which allows an information communication service provider who receives insurance money to be paid to the customer by the informed insurer to counterbalance an information communication service charge imposed by the customer with the insurance money.

### BRIEF DESCRIPTION OF DRAWINGS

FIG. 1 is a structural block diagram which shows one embodiment of the present invention.

FIG. 2 is a structural block diagram for illustrating an alarm for a problem of an information communications network system.

FIG. 3 is an explanatory diagram of a database structure of problem duration times of an information communications network system used in a recovery management system and a compensation management system.

FIG. 4 is an explanatory diagram of compensation criteria.

FIG. 5 is an explanatory diagram of an intra-business information communication system using a fast data communications network.

FIG. 6 is an explanatory diagram of a virtual private information communications network system using a public fast data communications network.

### BEST MODE FOR CARRYING OUT THE INVENTION

An embodiment of the present invention will now be described with reference to the accompanying drawings.

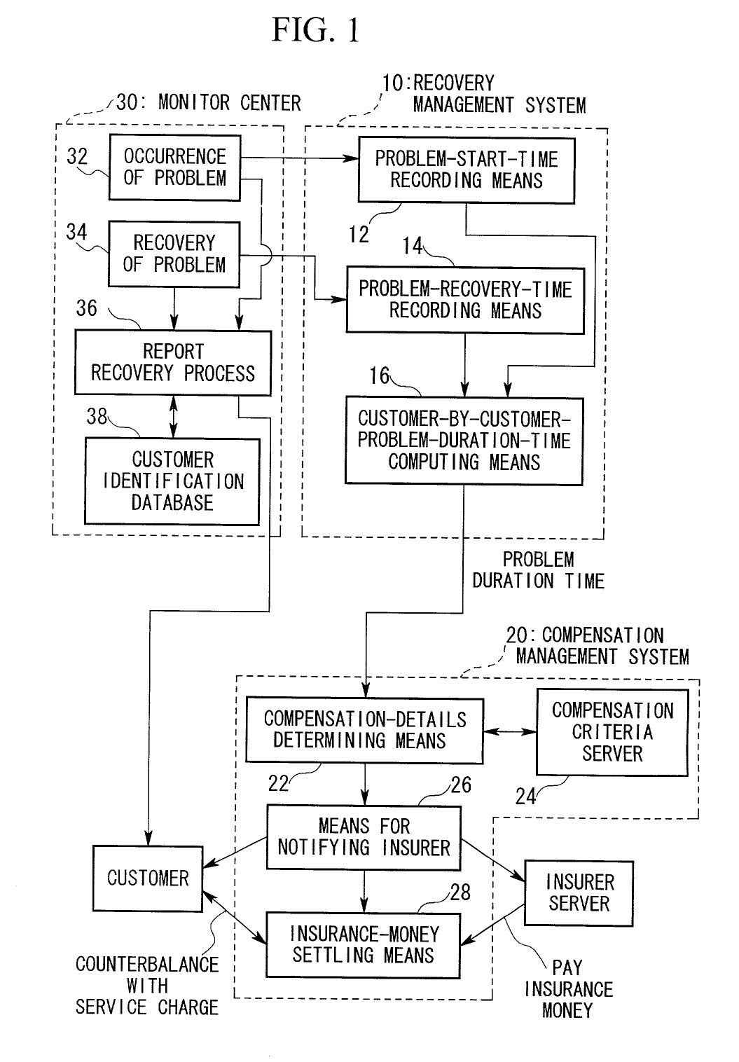

FIG. 1 is a structural block diagram for explaining one embodiment of the present invention. In the diagram, a recovery management system 10 comprises problem-start-time recording means 12 of information communication network system, problem-recovery-time recording means 14 and customer-by-customer-problem-duration-time computing means 16. The problem-start-time-recording means 12 of information communication network system records a problem start time using a log of an alarm for a problem affecting an information communications network system or means which can specify a previously registered customer. The log of an alarm for a problem affecting an information communications network system includes one arising from a delay in the data to be relayed over a network and one arising from a failure of software or a unit connected to a network, in addition to one arising from an interruption to the network itself, such as a log or the like in a case where a communication failure occurs in the service range of a relay IP network which is used between ONU/DSU at terminals in a fast exclusive line services and is used between ONU/DSU of access lines for fast IP extra network services.

An ONU (Optical Network Unit) is an abbreviated name for optical subscriber line network unit and performs conversion between transmission signals on an optical fiber and transmission signals corresponding to various kinds of terminal units, such as telephones. A DSU (Digital Service Unit), which is an abbreviated name for a digital line terminal unit, is sited in a user's home, terminates a digital subscriber line and provides an interface with digital terminals. The means which can specify a customer is notification of a caller number which is executed at the time of connecting to the Internet via dial-up. At the time an Internet user enters into a contract with a provider, the user pre-registers the telephone number to be used. At the time the Internet user connects to a fast data communications network IP through the provider, an Internet user ID and the registered telephone number are checked, thereby preventing another user from using the Internet in place of the registered one.

The problem-recovery-time recording means 14 registers the time when contact is made to a customer by a monitor center 30 after the problem affecting the information communications network system has been resolved, by using the means in the monitor center 30, which can specify a customer. The means that can specify a customer includes not only notification of a caller number (Caller ID) of a telephone system, but also authentication by an IP address or using both an ID and a password and authentication using a fingerprint, voiceprint, iris, etc. which are the biological physical characteristics of an operator. A report may be made to a customer by electronic mail, voice mail or facsimile in addition to telephone. For each target information communications network system of a customer, the customer-by-customer-problem-duration-time computing means 16 computes a problem duration time affecting the information communications network system from the problem start time of the information communications network system and from the time of contact to the customer.

A compensation management system 20 comprises compensation-details determining means 22, a compensation criteria server 24, means for notifying insurer 26 and insurance-money settling means 28. The compensation-details determining means 22 determines the details of compensation to a customer using the problem duration time calculated by the recovery management system 10 in the information communications network system and compensation criteria retained in the compensation criteria server 24. The details of the compensation will be discussed later. The means for notifying insurer 26 notifies a customer and an insurer of the details of compensation. This notification may be made on-line using an information communications network system or may be an off-line transaction, such as via a floppy disk or mail. The insurance-money settling means 28 makes a settlement which allows an information communication service provider to receive insurance money to be paid to the customer by the informed insurer and to counterbalance an information communication service charge imposed by the customer with the insurance money.

The monitor center 30 has a function 32 of detecting the occurrence of a problem of an information communications network system, a function 34 of detecting the resolution of the problem, a function 36 of reporting the problem recovery process to a customer, and a customer identification database 38. Recorded in the customer identification database 38 are the telephone number of a customer at the place of contact, a contracted communication capacity, etc.

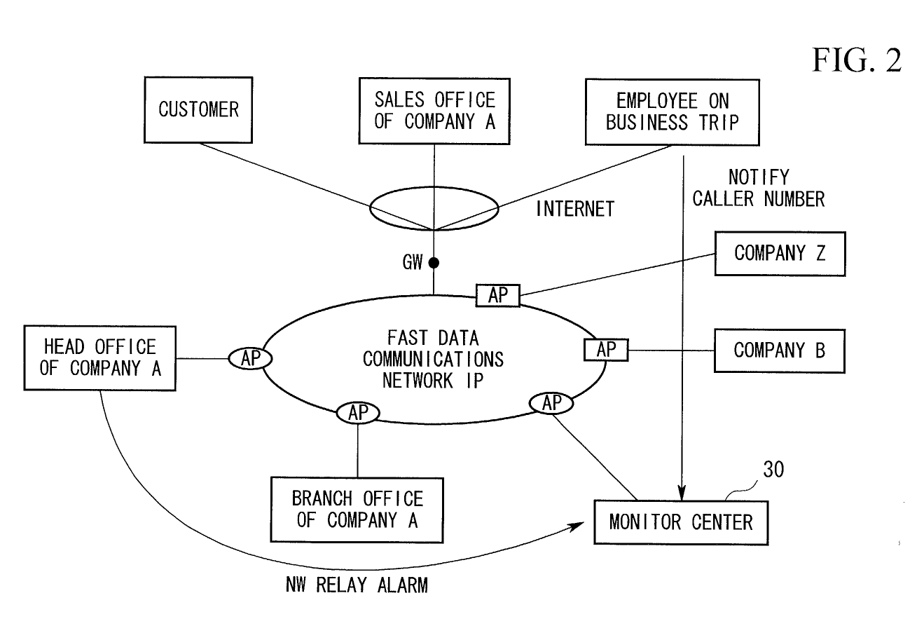

FIG. 2 is a structural block diagram for explaining an alarm triggered by a problem affecting an information communications network system. The monitor center 30 is connected to a fast data communications network IP. The monitor center 30 may be a CSC (Customer Service Center). When a communication failure occurs in the fast data communications network IP between, for example, the head office of company A and branch offices of company A, the monitor center 30 tries to maintain traffic using other routes of the fast data communications network IP. If there is no substitute fast data communications network IP, however, the monitor center 30 receives an alarm for a problem affecting the information communications network system from the fast data communications network IP. In the case where an employee on a business trip tries accessing the head office of company A via a gateway GW of the fast data communications network IP experiences a communication failure, notification of the caller number associated with the call by the employee on a business trip is made from the fast data communications network IP.

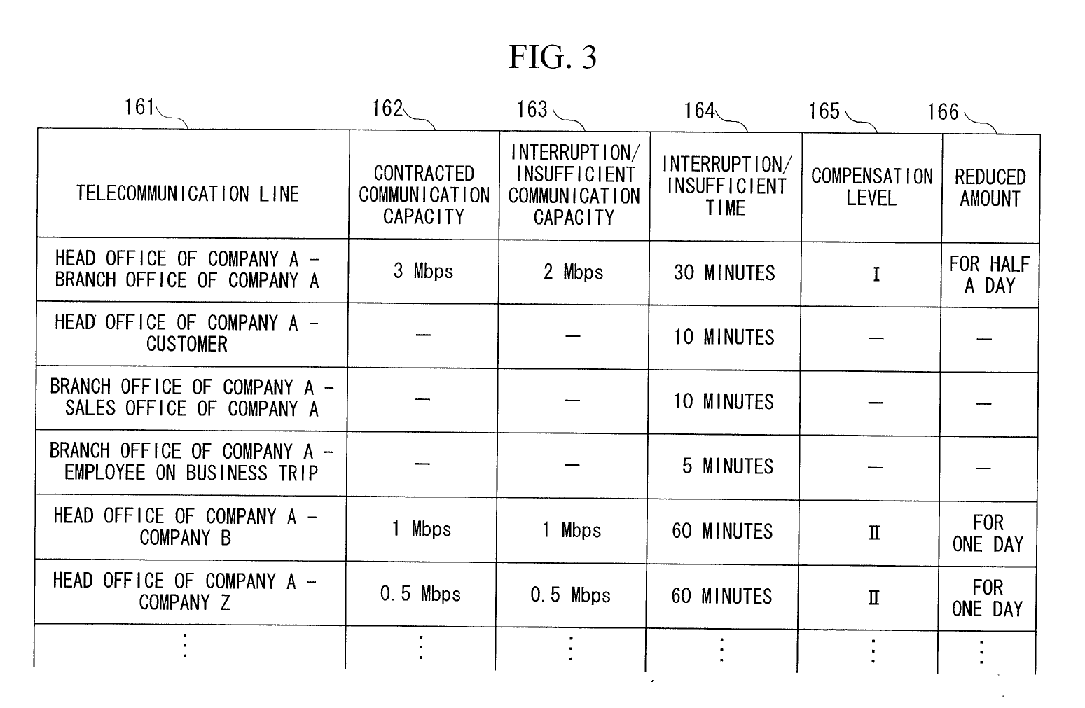

FIG. 3 is an explanatory diagram of a database structure showing problem duration times for an information communications network system which is used in the recovery management system and the compensation management system. The database for problem duration times affecting an information communications network system is managed monthly or yearly for each customer. A telecommunication line column 161 is a record of the contract subjects of telecommunication lines, and shows “head office of company A—branch office of company A” in the case of a fast data communications network IP between the head office of company A and a branch office of company A. A contracted communication capacity column 162 is a record of contracted communication capacities for fast data communications networks IP, and shows, for example, 3 Mbps. In the case of connecting via the Internet, “−” is described because it does not have a direct contract relationship with the fast data communications network IP.

An interruption/insufficient communication capacity column 163 shows to what degree the communication capacity has fallen short at the time when an alarm is triggered signaling a problem affecting the information communications network system with respect to the contracted communication capacity of the fast data communications network IP. In the case where the communication capacity is insufficient although a bypass communication path has been secured, the insufficient communication capacity is recorded, and in the case of disabled communications, the contracted communication capacity is described. An interruption/insufficient time column 164 describes problem duration times that are computed from the problem start times of information communications network systems and from the times when contact is made to customers. A compensation level column 165 shows compensation classes with respect to the problem duration times affecting an information communications network system when applied to the compensation criteria server 24. A reduced amount column 166 describes an amount of money deducted as compensation money from a monthly charge for line usage in accordance with the compensation class described in the compensation level column 165; for example, the deducted amount of money becomes “for half a day” for compensation level “I”.

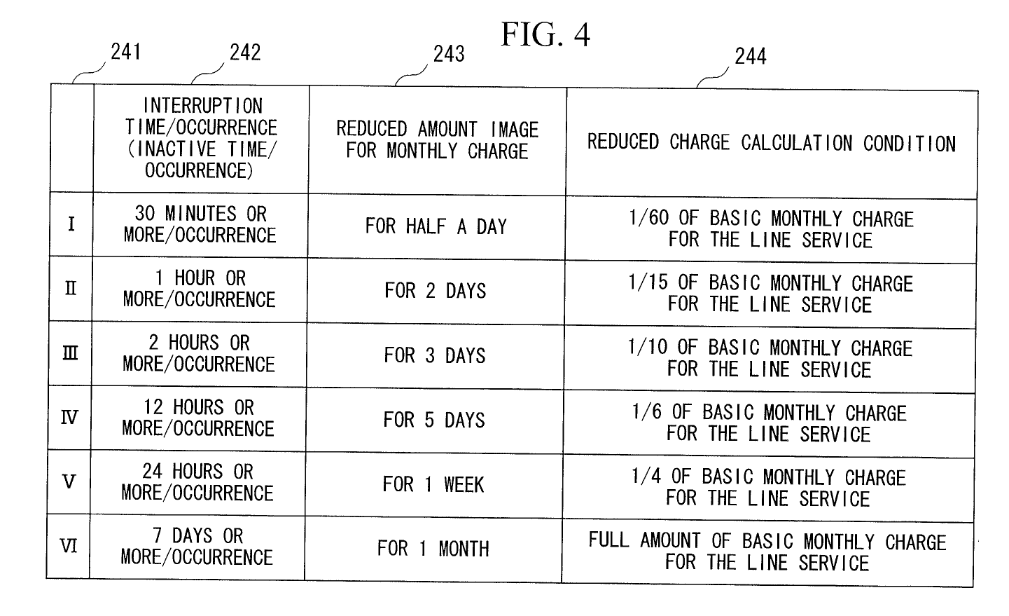

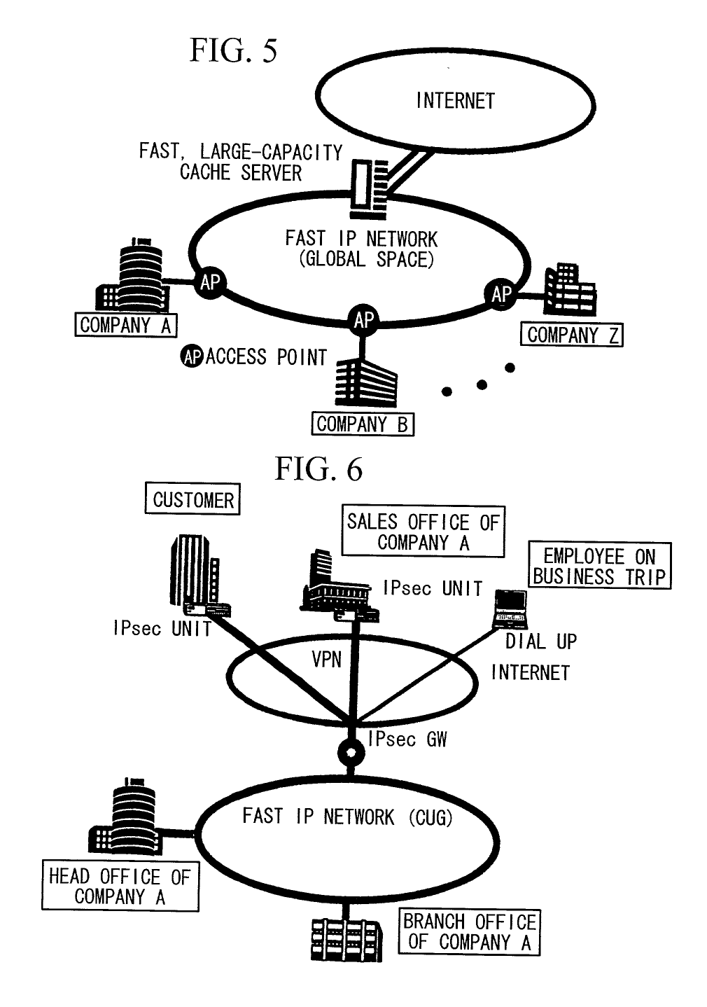

FIG. 4 is an explanatory diagram showing compensation criteria. A compensation level column 241 has six classes from level I to level VI. An interruption time column per occurrence 242 defines, for example, that the interruption time per occurrence is equal to or greater than 30 minutes and less than 60 minutes for level I. That is, if the interruption time per occurrence is less than 30 minutes, it is considered to be minor damage and thus a subject for exemption. A reduced amount image column 243 shows a reduced amount image with a communication charge per month as a reference; for example, the reduced amount image for level I is described as for half a day. A reduced charge calculation condition column 244 describes a multiplying factor for a reduced charge with respect to the basic monthly charge for line service; for example, the multiplying factor for level I is described as 1/60. Further, it is specified that the upper limit of the reduced charge for level VI is the basic monthly charge for line service, thereby preventing the management of the information communication service provider from being overly affected by overpayment of compensation money to a customer.

Information communications network systems face various possible risks. In the case of doing electronic commerce over a network, factors are line disconnection, power cutoff, illegal access, infection by a computer virus, program bugs, natural disasters, such as water leaks, lightning and fire, miscalculation on acceptance of data management for a customer and so forth. Some types of damage which could occur would be hindrance to business activity due to an interruption of network function, e.g., the case where a customer or third party has suffered an economical reversal, defamation or invasion of a privacy, damage to equipment, erasure or alteration of information, and so forth. With respect to hindrances to business activity, the necessary compensation would be for lost sales and the increased costs incurred to maintain the business by alternative means. With respect to invasion of privacy or the like, there is a legal liability for reparation. With respect to damage to equipment, there is the cost of repairing the equipment and the cost of restoring lost information.

Insurers therefore provide special contracts for reparation liability insurance to compensate for various latent risks specific or related to information communications network systems. As compensation for direct damages caused by a failure, there are specific subjects that attract compensation, such as compensation for profit loss, compensation for costs incurred to keep the business going, compensation for costs incurred in repairing information media and compensation for costs associated with the repair of network units. For expanded damages caused by a failure, there is some liability for reparation.

The compensation for profit loss is to compensate for a certain percentage of the lost sales with the profit ratio as the upper limit, in the case where the information communications network system of a customer has stopped due to an unforeseen and unexpected cause and sales have fallen during the inactive period of the information communications network system. A typical problem is when a production line has stopped due to the deactivation of the control network of the production line, so that the profit during the affected period has dropped.

The compensation for costs incurred to keep the business going is to compensate costs suffered by a customer incurred in keeping the business going in the case where the information communications network system of a customer has stopped due to an unforeseen and unexpected cause and a substitute means has been secured in order to prevent the sales from dropping during the inactive period of the information communications network system. A typical problem is that an information communications network system has stopped, which has disabled the business on-line, so that arrangements for a substitute line have to be made to continue the business.

The compensation for costs incurred in repairing information media is to compensate for restoration costs in the case where information media or the information itself has been damaged by illegal access or infection from a computer virus. A typical problem is that the Internet software has proven to be defective, and consequently data in a personal computer has been lost and its restoration represents a cost to the company affected.

The compensation for costs associated with the repair of network units is to compensate for repair costs in the case where hardware equipment owned by a customer, such as a desktop-type personal computer, a notebook-type personal computer, a router or the like, has been damaged. A typical problem is that a desktop-type personal computer has been damaged due to illegal access and its repair represents a cost.

The compensation for reparation liability is to compensate for reparation made to a customer or third party as a result of illegal access to or infection from a computer virus affecting the information communications network system of a customer. A typical problem is where the management of software programs for information communications network system has been inadequate, resulting in the customer making a claim for reparation, saying “the disconnection of the line stopped the information communications network system capability, which disabled transmission of sales information, thus resulting in reduced business profits.”

The above-described embodiment has demonstrated the case where there are separate insurers and information communication service providers, and where the information communication service provider comprehends the duration of a problem affecting an information communications network system, where the insurer pays insurance money in accordance with the compensation criteria, and the information communication service provider counterbalances the communication charge with the insurance money. The invention is not limited to this case, but an information communication service provider may serve as an insurer as long as the damages according to the duration of a problem affecting the information communications network system is compensated and the insurance money is counterbalanced with the charge for the information communication service. In the case where an insurer provides reparation liability insurance to compensate for the aforementioned problems affecting an information communications network system and for the various risks that come up in electronic commerce, the structure may be modified in such a way that an information communication service provider may not only comprehend the duration of a problem affecting the information communications network system but also comprehend the cost of repairing information units connected to the network equipment and information restoration costs via the information communications network system.

Although the instance of using an Internet protocol as a fast data communications network IP has been illustrated, other standard communication protocols, such as those selected by WAP (Wireless Access Protocol) or ISO (International Standards Organization) or CCITT (Consultative Committee on International Telephony and Telegraphy), may also be used. Although the above-described embodiment has illustrated the case where the communication charge is counterbalanced with the insurance money when an information communication service provider is a communication firm, the information communication service charge may be counterbalanced with the insurance money when VAN (Value Added Network) firms, such as an Internet provider, an agent of property market information or a stockbroker etc., collect information communication service charges.

### INDUSTRIAL APPLICABILITY

The present invention provides a technique for realizing a management system for an information communications network system, which will allow communication firms to obtain information about the quality of communication services to customers by managing the duration of interruptions to the information communications network system. In addition, the invention provides a technique for realizing a management system for an information communications network system, which compensates for direct damages to information communication service users and expanded damages, caused by interruption to an information communications network system, when the information communications network system has been unavoidably interrupted for a given period of time.

1. A management system for an information communications network system comprising:
means for recording a problem start time of said information communications network system;
means for recording a time of contact made to a customer by a monitor center after said problem has been resolved; and
means for computing a problem duration time from said problem start time and from said time of contact to said customer.

2. A management method for an information communications network system comprising the steps of:
a step of recording a time at which a problem of said information communications network system has started;
a step of reporting a recovery process to a customer by a monitor center after detection of said problem; and
a step of recording a time of contact made to said customer by said monitor center after said problem has been resolved.

3. A management system for an information communications network system comprising:
means for determining details of compensation to a customer using a problem duration time affecting said information communications network system and compensation criteria;
means for notifying said customer and an insurer of said details of compensation; and
means for making a settlement which allows an information communication service provider who receives insurance money to be paid to said customer by said informed insurer to counterbalance an information communication service charge imposed by said customer with said insurance money.

4. The management system according to claim 3, wherein said compensation criteria are so set as to exclude as a matter for compensating a problem when said problem duration time does not reach a given exemption value.

5. The management system according to claim 3, wherein said compensation criteria are so set as to reduce an information communications network system charge corresponding to said problem duration time when said problem duration time exceeds a given exemption value.

6. The management system according to claim 3, wherein said compensation criteria are set in such a way as to compensate for said problem even when said problem occurs due to a cause for which said information communication service provider is not responsible.

7. The management system according to claim 3, wherein said compensation criteria are set in such a way as to compensate for damages in a case where a cause for said problem has defamed, or invaded the privacy of, a customer or a third party, or has resulted in damage to equipment, and erasure or alteration of information.

8. A management method for an information communications network system comprising the steps of:
a step of recording a problem start time of said information communications network system;
a step of recording a time of contact made to a customer by a monitor center after said problem has been resolved;
a step of computing a problem duration time from said problem start time and said time of contact to said customer for each target information communications network system of said customer;
a step of notifying said customer and an insurer of details of compensation to said customer determined by using said problem duration time and compensation criteria; and
a step of making a settlement which allows an information communication service provider who receives insurance money to be paid to said customer by said informed insurer to counterbalance an information communication service charge imposed by said customer with said insurance money.
